(19) United States
(12) Patent Application Publication
(10) Pub. No.: US 2018/0246390 A1
(43) Pub. Date: Aug. 30, 2018

(54) NANOPHOTONIC RADIATORS WITH TUNABLE GRATING STRUCTURES FOR PHOTONIC PHASED ARRAY ANTENNA

(71) Applicant: Korea Advanced Institute of Science and Technology, Daejeon (KR)

(72) Inventors: Hyo-Hoon Park, Daejeon (KR); Jong-Hun Kim, Daejeon (KR); Ji-Hwan Park, Daejeon (KR)

(73) Assignee: Korea Advanced Institute of Science and Technology, Daejeon (KR)

(21) Appl. No.: 15/523,664

(22) PCT Filed: Dec. 1, 2015
(86) PCT No.: PCT/KR2015/012946

§ 371 Date: May 1, 2017

(30) Foreign Application Priority Data
Nov. 17, 2015 (KR) 10-2015-0160843
Nov. 30, 2015 (KR) 10-2015-0168710

(51) Int. Cl. G02F 1/295

(52) U.S. Cl. CPC G02F 1/2955; G02F 2201/305

(57) ABSTRACT

A photonic radiator forming a photonic phased array antenna includes a light waveguide including a waveguide clad and a waveguide core using semiconductor materials, and a grating periodically formed on an upper or lower part of the light waveguide, wherein the photonic radiator receives an input light wave in a direction of the grating and the light waveguide, radiates an output light wave to a space through scattering from the grating, and varies an effective refractive index of the grating through voltage supply or current injection in the vicinity of the photonic radiator to adjust a radiation angle of the output light wave that is radiated to the space.

### TECHNICAL FIELD

Embodiments of the inventive concept relate to a radiator structure for application to a photonic phased array antenna and more particularly, to a radiator structure using a grating structure which is able to be modulated with a longitudinal radiation angle of the grating to radiate a light wave toward a free space of the grating.

### BACKGROUND ART

A photonic phased array antenna may be used as a light source of scanning a photonic beam for image scanning in an autonomous car or robot. The photonic phased array devices demanded in various applications usually require small size, high efficiency of photonic beam radiation, clear beam formation, and wide beam scanning range. Among these requirements, for miniaturization of the device, there is a need to integrate the photonic phased array antenna structures based on semiconductor materials. Since the efficiency of beam radiation and the functions of beam forming and scanning are sensitively dependent on the structure of radiator part in the optical phased array, we propose in this patent detailed structures of the photonic radiator based on semiconductor materials.

A semiconductor material includes a silicon or compound semiconductor, a metallic thin film material, and a dielectric material such as silicon nitride or silicon oxide which is used for manufacturing photonic devices made of the silicon or compound semiconductor.

In addition, the radiation angle of a tunable grating structure is controlled in the longitudinal direction of gratings and the means of control thereof are provided through variation of a refractive index based on an electro-optic effect or a thermo-optic effect. Both effects can be obtained by a voltage supply or a current injection in the grating structure with a p-type or n-type doped region in the gratings or the peripheral area.

There have been proposed nanophotonics phased array antenna with silicon semiconductor-based grating structures through a foregoing invention (PCT/KT2015/012199), made by our laboratory of the present application, and another foregoing invention (US Patent Application No. 2014/0192394 A1).

In the grating-structured photonic radiator of the foregoing invention, a longitudinal radiation direction of an output light wave radiated from the gratings is limited to specific directions by a period of gratings and a wavelength of incident light. Because of that, a longitudinal scanning range of a phase-matched beam is restricted in a narrow range.

In detail, in an M×N two-dimensional (2D) phased array antenna structure (e.g., US Patent Application No. 2014/0192394 A1), it needs to provide a phase variation in a column direction, that is, a longitudinal direction, of the matrix-type 2D phased array for continuous control of a radiation direction along the longitudinal direction. However, 2D phased arrays have problems of requiring a complex structure of 2D arrangement to attain a phase control along a column direction, and restricting a longitudinal scanning range, virtually, in a degree narrower than 10° considering the limited space of the 2D array where many related components should be integrated in each unit cell of the array.

In a 1×M one-dimensional (1D) photonic radiator array, it may be possible to actively change a longitudinal radiation direction through a change of an incident wavelength. However, to change an incident wavelength, there is a problem of using a tunable light source providing a modulation of wavelength in a wide range.

In detail, a basic structure of a 1×M phased array antenna proposed by the foregoing invention (PCT/KR2015/012199) made by our laboratory of the present application is as shown in FIG. 1. In FIG. 1, the phased array antenna is configured with the following main elements such as a light source 100, photonic power distributors 101-1 and 101-2, phase controllers 102, and photonic radiators 104. These elements are respectively connected through waveguides 106. For example, the phase controllers 102 and the radiators 104 are connected to each other through the waveguide 106. Considering the importance of arrangement of the waveguide 106 in front of the radiator 104 which may cause a coupling due to a closed configuration near the radiator, the waveguide 106 between the phase controller 102 and the radiator 104 is shown differently as phase-feeding lines 103.

The phased array of FIG. 1 has a feature configuring the photonic power distributors 101-1 and 101-2, the phase controllers 102, and the phase-feeding lines 103 out of the region of 1×M radiator array 105 to reserve a space in the region of radiators. In such a case as a 1×M array of FIG. 1, it is impossible to attain a scanning in a vertical direction (a longitudinal direction of the radiator), if only a phase change is provided along laterally aligned radiators. Because of that, the foregoing invention (PCT/KR2015/012199) proposed a tunable radiator structure attaining an active beam scanning in vertical direction without any phase control for vertical scanning or any tunable light source. Since an active beam scanning in vertical direction may be impossible from foregoing conventional types of 1×M phased arrays or (1×M)×N phased arrays with a fixed incident wavelength, the tunable grating structure of this invention can be usefully applied in the radiator part of both types of phased arrays abovementioned.

### DETAILED DESCRIPTION OF THE INVENTION

### Technical Problem

Accordingly, the inventive concept proposes a radiator structure capable of active modulation of a longitudinal (vertical) radiation angle without using longitudinal phase control or a tunable light source.

Embodiments of the inventive concept provides a solution for accomplishing a 2D scanning function, including both transverse and longitudinal directions, only with one 1×M 1D array by applying a photonic radiator which is capable of modulating a longitudinal radiation angle.

### Technical Solution

According to an embodiment of the inventive concept, a photonic radiator forms a photonic phased array antenna, the photonic radiator includes a light waveguide including a waveguide clad and a waveguide core using semiconductor materials, and a grating periodically formed on an upper or lower part of the light waveguide, wherein the photonic radiator is configured to receive an input light wave in a direction of the grating and the light waveguide, to radiate an output light wave to a space through scattering from the grating, and to vary an effective refractive index of the grating through voltage supply or current injection in the vicinity of the photonic radiator to adjust a radiation angle of the output light wave that is radiated to the space.

The photonic radiator may adjust the radiation angle to widen a range in a longitudinal direction of the grating.

The photonic radiator may vary the effective refractive index of the grating by using an electro-optic effect from the voltage supply or the current injection.

In the photonic radiator, a p-n junction structure may be formed in or in the vicinity of the grating to use the electro-optic effect from the voltage supply or the current injection.

The photonic radiator may be formed of a p-i-n junction structure in or in the vicinity of the grating to use the electro-optic effect from the voltage supply or the current injection.

The photonic radiator may also vary the effective refractive index of the grating by using a thermo-optic effect from the current injection.

The photonic radiator may be formed of a doped region with one of p-type or n-type in or in the vicinity of the grating to use the thermo-optic effect from the current injection, and may increase temperature of the grating region through the Joule heat that is generated by injecting a current into the doped region.

The photonic radiator may be formed of a p-n junction in or in the vicinity of the grating to use the thermo-optic effect from the current injection, and may increase temperature of the grating region through the Joule heat that is generated by injecting a current into the p-n junction.

The photonic radiator may supply a reverse-biased voltage to the p-n junction, which is formed in or in the vicinity of the grating, to use the thermo-optic effect, and may increase temperature of the grating region through a breakdown current due to a voltage that is equal to or higher than a breakdown voltage.

### Advantageous Effects of the Invention

It may be possible to accomplish a 2D scanning function, including both transverse and longitudinal directions, only with one 1×M 1D array by applying a photonic radiator which is able to modulate a longitudinal radiation angle.

### DESCRIPTION OF THE DRAWINGS

FIG. 1 is a schematic diagram illustrating main elements of a photonic phased array antenna proposed by a foregoing invention.

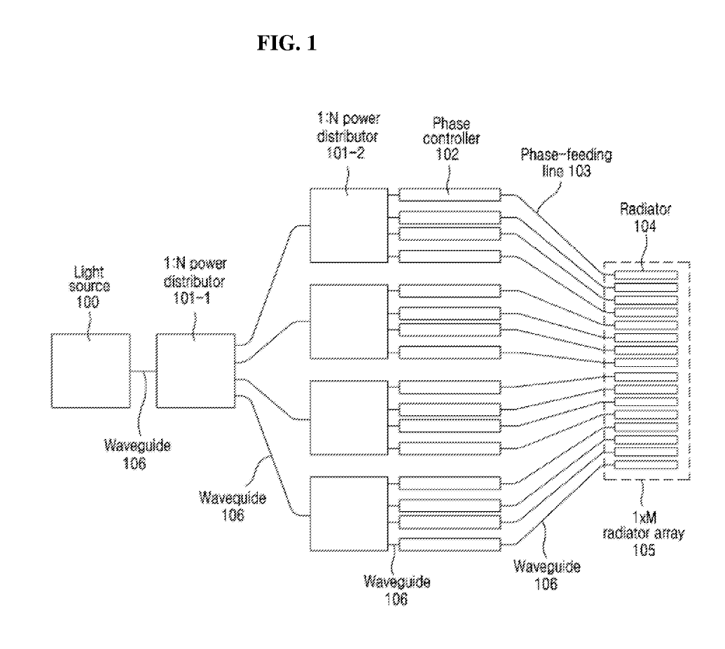

FIGS. 2A and 2B are schematic diagrams illustrating a basic structure of a photonic radiator according to the inventive concept.

FIGS. 3A and 3B illustrate a structure of a photonic radiator constituted with a p-n junction, as a structure of a tunable grating radiator, which is able to be controlled by an electro-optic effect, according to an embodiment of the inventive concept.

FIGS. 4A and 4B illustrate a structure of a photonic radiator constituted with a p-i-n junction, as a structure of a tunable grating radiator, which is able to be controlled by an electro-optic effect, according to an embodiment of the inventive concept.

FIGS. 5A and 5B illustrate a structure of a photonic radiator constituted with a p or n-type doped region, as a structure of a tunable grating radiator, which is able to be controlled by a thermo-optic effect, according to an embodiment of the inventive concept.

FIGS. 6A and 6B illustrate a structure of a photonic radiator constituted with a p-n junction, as a structure of a tunable grating radiator, which is able to be controlled by a thermo-optic effect, according to an embodiment of the inventive concept.

### MODE OF THE INVENTION

Hereinafter, a grating radiator according to embodiments of the inventive concept will be described below in conjunction with the accompanying drawings. These embodiments of the inventive concept are just described to show practical details without any intention for restricting and defining the scope of the inventive concept. All matters easily derivable from these embodiments of the inventive concept are construed as being included in the scope of the inventive concept.

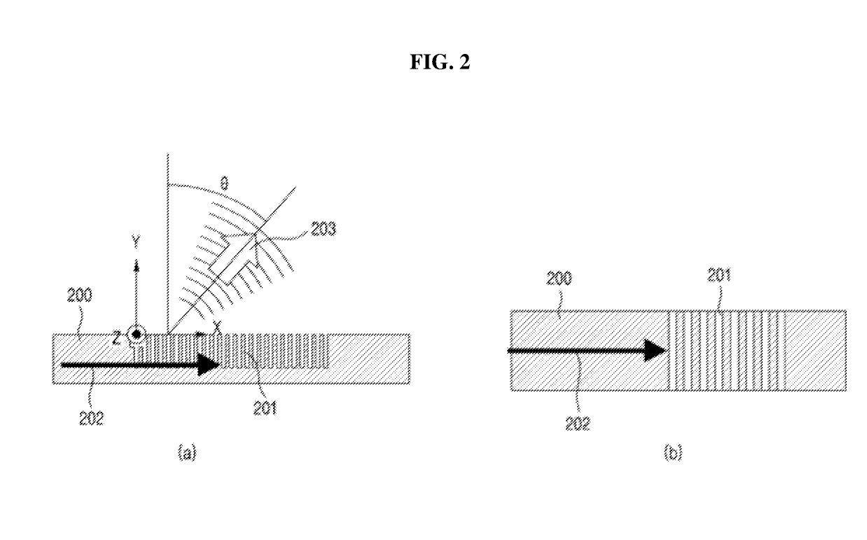

FIGS. 2A and 2B are schematic diagrams illustrating a basic structure of a photonic radiator according to an embodiment of the inventive concept. In detail, FIG. 2A is a longitudinal sectional view illustrating the photonic radiator and FIG. 2B is a top view illustrating the photonic radiator.

Referring to FIGS. 2A and 2B, a radiation angle of a far field 203 of an output light wave radiated from a grating structure may be designed by using Equation 1 from diffraction theory.

λ₀/Λ_{g}=n_{eff}−n_{c} sin θ [Equation 1]

In Equation 1, λ₀ denotes a central wavelength of an input light wave in a free space, Λ_{g} denotes a period of a grating, n_{eff} denotes an effective refractive index of a waveguide (a whole waveguide including a core and a clad) including gratings, n_{c} denotes a refractive index of a clad covering a core of a waveguide where a grating is formed, and θ denotes a radiation angle (e.g., an angle from a normal direction of a grating surface) corresponding to a center of light field at which the light intensity shows a maximum value in a diffraction pattern scattered from the grating.

Hereupon, the effective refractive index n_{eff} is determined depending on a structure of a waveguide based on real refractive indexes of materials constituting the waveguide core and clad for a wavelength of a light wave. Additionally, a refractive index of a clad may be expressed as n_{c}=1 in the case that a grating is exposed to a free space. This equation is based on a classical diffraction theory, but such a classical diffraction theory has a problem describing exactly the radiation direction in the case that geometric dimensions of a period of a grating, and a width and a thickness of a waveguide core are equal to or smaller than a diffraction limit, that is, a half wavelength (λ₀/2) of an input light wave. However, the general dependence of the radiation angle on a wavelength and refractive indexes may be estimated by Equation 1. Therefore, the inventive concept proposes a radiator structure which can change a radiation angle θ by electrical control of an effective refractive index n_{eff}.

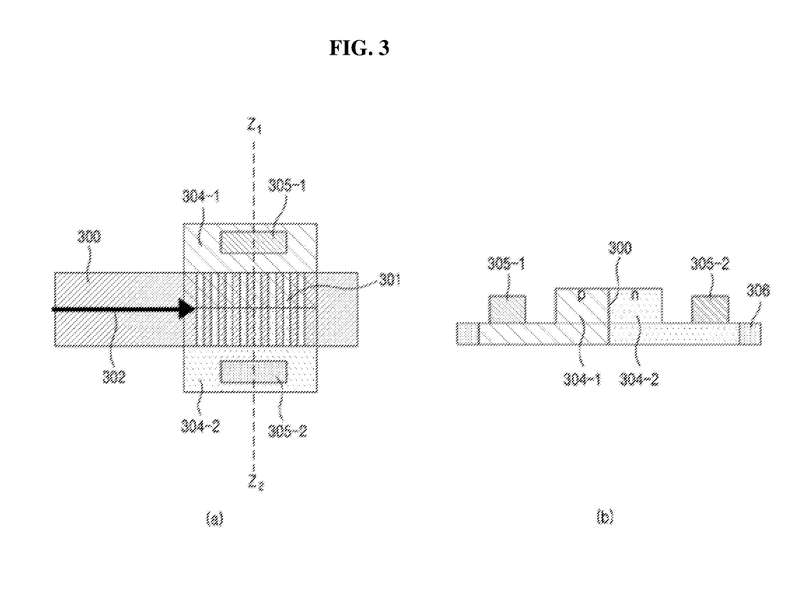

FIGS. 3A and 3B illustrate a structure of a photonic radiator constituted with a p-n junction, as a structure of a tunable grating radiator, which is able to be controlled by an electro-optic effect, according to an embodiment of the inventive concept. In detail, FIG. 3A is a top view and FIG. 3B is a transverse sectional view along line Z₁-Z₂.

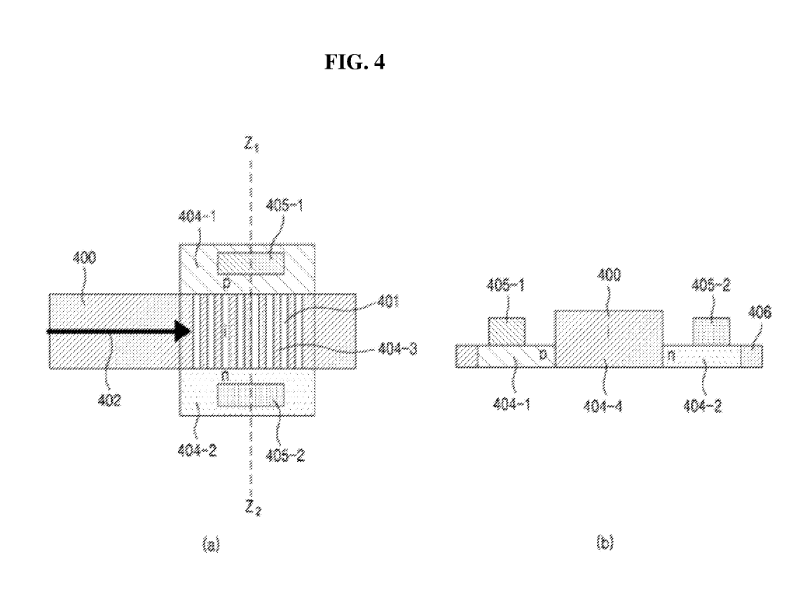

FIGS. 4A and 4B illustrate a structure of a photonic radiator constituted with a p-i-n junction, as a structure of a tunable grating radiator, which is able to be controlled by an electro-optic effect, according to an embodiment of the inventive concept. In detail, FIG. 4A is a top view and FIG. 4B is a transverse sectional view along line Z₁-Z₂.

Referring to FIGS. 3A and 3B employing a p-n junction structure, as illustrated in FIG. 3A, a p-type doped region 304-1 and an n-type doped region 304-2 may be formed in and in the vicinity of a grating region 301 of a waveguide core 300. Additionally, electrodes 305-1 and 305-2 may be formed in the p-type doped region 304-1 and the n-type doped region 304-2 which are placed in the vicinity of the waveguide core 300.

If a voltage or current is supplied between the two electrodes 305-1 and 305-2 while an input light wave 302 is incident along the light waveguide core 300, carrier concentrations of electrons or holes are changed in the doped regions 304-1 and 304-2 and thus a refractive index of the doped regions are varied due to the electro-optic effect, specifically, a free carrier plasma dispersion (FCPD) effect. This variation of the refractive index may change a radiation angle θ of an output light wave, as indicated by 203 in FIG. 2A, which is radiated from the grating 301 of the doped regions. The electro-optic effect and the FCPD effect are well known in semiconductor optics and thus will not be further described.

Referring to FIGS. 4A and 4B employing a p-i-n junction structure, as illustrated in FIG. 4A, a p-type doped region 404-1, an i-type region 404-3, and an n-type doped region 404-2 may be formed in and in the vicinity of a grating region 401 of a waveguide core 400. Additionally, electrodes 405-1 and 405-2 may be formed in the p-type doped region 404-1 and the n-type doped region 404-2 which are placed in the vicinity of the grating region 401.

If a voltage or current is supplied between the two electrodes 405-1 and 405-2, a refractive index of the carrier injected regions will vary due to the electro-optic effect, that is, an FCPD effect, in the mechanism aforementioned in conjunction with FIG. 3. This variation of the refractive index may change a radiation angle θ of the output light wave 203 which is radiated from the grating region 401 where carriers are injected.

A preferred method of more effectively obtaining refractive index variation from voltage or current supply is supplying a reverse bias to the p-n junction structure of FIG. 3 to extract carriers or supplying a forward bias to the p-i-n junction structure of FIG. 4 to inject carriers.

In these cases, a radiation angle θ of the output light wave radiated from the grating region 401 may be controlled through a proper adjustment of a voltage supplied to the electrodes 405-1 and 405-2, for example.

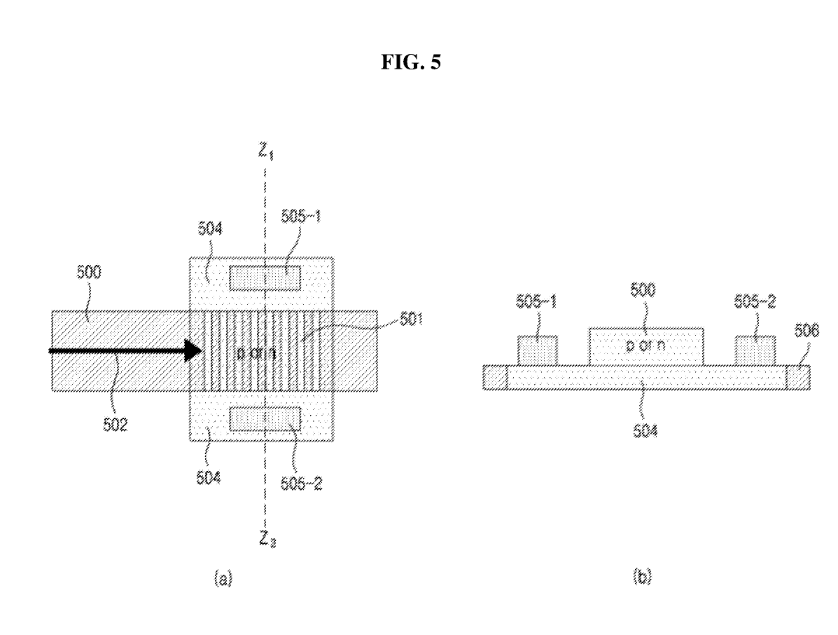

FIGS. 5A and 5B illustrate a structure of a photonic radiator constituted with a p or n-type doped region, as a structure of a tunable grating radiator, which is able to be controlled by a thermo-optic effect, according to an embodiment of the inventive concept. FIG. 5A is a top view and FIG. 5B is a transverse sectional view along line Z₁-Z₂.

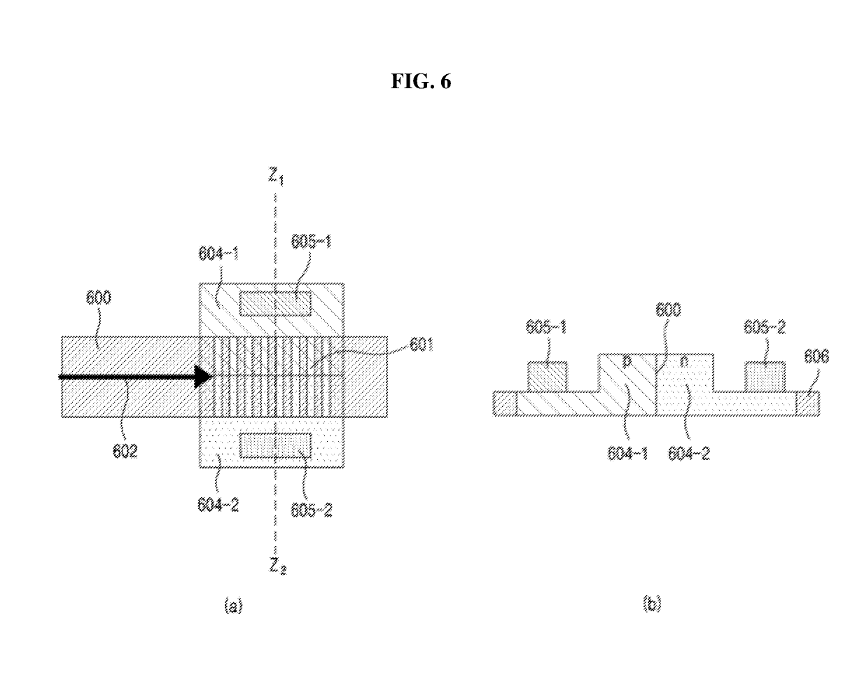

FIGS. 6A and 6B illustrate a structure of a photonic radiator constituted with a p-n junction, as a tunable grating radiator, which is able to be controlled by a thermo-optic effect, according to an embodiment of the inventive concept. FIG. 6A is a top view and FIG. 6B is a transverse sectional view along line Z₁-Z₂.

Referring to FIGS. 5A and 5B illustrating the photonic radiator formed of a p or n-type doped region, as illustrated in FIG. 5A, a doped region 504 with one of p-type and n-type may be formed in or in the vicinity of a grating region 501 of a waveguide core 500. Additionally, electrodes 505-1 and 505-2 may be formed in the p or n-type doped region 504 which is placed in the vicinity of both sides of the light waveguide core 500.

As such, the purpose of forming the p or n-type doped region 504 is to guide a current through the doped region where resistance thereof is lower than the peripheral. Accordingly, if a current is supplied between the two electrodes 505-1 and 505-2 in the state that an input light wave 502 is incident along the light waveguide core 500, the current generates Joule heat and temperature increases therein. If temperature of the doped region 504 increases, an effective refractive index of the grating region 501 will vary due to the thermo-optic effect.

Accordingly, a radiation angle θ of the output light wave 203 radiated from the grating 501 in the doped region may vary due to such refractive index variation. The thermo-optic effect is well known in semiconductor optics and thus will not be further described.

The photonic radiator structure illustrated in FIGS. 5A and 5B may be available regardless of a direction of current injection between the two electrodes 505-1 and 505-2. In other words, it is permissible to force a current to flow from the electrode 505-1 toward the electrode 505-2 by supplying a relatively positive (+) voltage to the electrode 505-1 and by supplying a relatively negative (−) voltage to the electrode 505-2, or to force a current to flow from the electrode 505-2 toward the electrode 505-1 by reversely supplying the relatively positive (+) and negative (−) voltages respectively to the electrodes 505-2 and 505-1. As the current increases, the temperature by Joule heating increases, and thus the magnitude of refractive index variation increases. Therefore, a radiation angle θ may be controlled through the change of the current.

Referring to FIGS. 6A and 6B employing a p-n junction structure, as illustrated in FIG. 6A, a p-type doped region 604-1 and an n-type doped region 604-2 may be formed in or in the vicinity of the grating region 601 of the waveguide core 600. Additionally, electrodes 605-1 and 605-2 may be formed in the p-type doped region 605-1 and the n-type doped region 605-2 in the vicinity of the waveguide core 600.

In this structure, although the two types of doped regions, that is, the p-type doped region 604-1 and the n-type doped region 604-2, are joined to each other, it is possible to guide a current therethrough because the doped regions have lower resistance than the peripheral region. Accordingly, if a current flows between the two electrodes 605-1 and 605-2 when a light wave is incident along the waveguide core 600, Joule heat from the current may be generated to increase the temperature of the doped regions 604-1 and 604-2. If the temperature of the doped regions 604-1 and 604-2 increases, refractive index may vary due to the thermo-optic effect. Due to variation of the refractive index, it is possible to change a radiation angle θ of an output light wave 203 radiated from the grating region 601.

In the structure of the photonic radiator illustrated in FIGS. 6A and 6B, an increment of temperature may be dependent on a direction of voltage supply between the two electrodes 605-1 and 605-2. In the case of supplying a forward-biased voltage between the two electrodes 605-1 and 605-2, when voltage increases continuously from 0, current also continuously increases from 0. Accordingly, an effective refractive index may vary continuously.

In contrast, in the case of supplying a reverse-biased voltage between the two electrodes 605-1 and 605-2, the current thereof may be small until a breakdown voltage, and then may increase abruptly if the reverse-biased voltage increases beyond the breakdown voltage. Accordingly, temperature increase of the doped regions 604-1 and 604-2 and variation of an effective refractive index due to a thermo-optic effect may also appear effectively after the breakdown voltage.

According to a study for a silicon-based grating coupler (Jung-Hun Kim et al., IEEE Photo. Tech. Lett., vol. 27, no. 21, p. 2034, Nov. 1, 2015), tuning efficiency represented in variation of refractive index versus current in a breakdown state under a reverse-biased voltage is higher than tuning efficiency under a forward-biased voltage in a p-n junction structure. Therefore, considering tuning efficiency in a grating-structured photonic radiator employing a p-n junction structure according to an embodiment of the inventive concept, it may be more preferred to use the breakdown state by supplying a reverse-biased voltage than by supplying a forward-biased voltage. In any case of supplying a forward-biased voltage or a reverse-biased voltage, since temperature increase from Joule heating becomes larger as a current increases, variation of an effective refractive index, that is, the control of a radiation angle θ, in the structure of the photonic radiator of FIGS. 6A and 6B may be controlled by the magnitude of a current injected between the electrodes 605-1 and 605-2 or the absolute value of a voltage supplied between the electrodes 605-1 and 605-2.

The aforementioned embodiments are simply provided to implement the inventive concept and may be variously modifiable in practical details. For example, while a p-n junction is described as locating in the center of the light waveguide core 301 or 601 where the grating is formed as illustrated in FIGS. 3A and 3B or FIGS. 6A and 6B, the location of the p-n junction may not be restricted or defined hereto and the p-n junction may even be located at any side in or out of the light waveguide core.

In the same manner, while a p-i junction and an i-n junction are described as locating respectively at the ends of sides of the waveguide core 401 where the grating is formed as illustrated in FIGS. 4A and 4B, the locations of the p-i junction and the i-n junction may not be restricted or defined hereto and the p-i junction and the i-n junction may even be located at any side in or out of the waveguide core.

Additionally, while the electrodes 305-1 and 305-2, 405-1 and 405-2, 505-1 and 505-2, or 605-1 and 605-2 are described as being formed on a p-type or n-type doped region in FIGS. 3A to 6B, the electrodes 305-1 and 305-2, 405-1 and 405-2, 505-1 and 505-2, or 605-1 and 605-2 may not be restricted or defined hereto and may even be formed on a p+ or n+ doped region having concentration higher than that of the p-type or n-type doped region of the grating 301, 401, 501, or 601 in order to reduce electrical resistance thereof.

Additionally, while the electrodes 305-1 and 305-2, 405-1 and 405-2, 505-1 and 505-2, or 605-1 and 605-2 are described as being locating in the vicinity of the sides of the waveguide core 301, 401, 501, or 601 where the grating is formed as illustrated in FIGS. 3A to 6B, the locations of the electrodes may not be restricted or defined hereto, and the electrodes 305-1 and 305-2, 405-1 and 405-2, 505-1 and 505-2, or 605-1 and 605-2 may be arranged at a location out of the side of the waveguide core for the purpose of supplying an appropriate voltage or arranging a current injection array.

Additionally, while a rib-type waveguide structure in FIG. 3B, 4B, 5B, or 6B is described with the case that the electrodes are described as being formed at a rib part (a part of the lower layer of the waveguide) 306, 406, 506, or 606 of the waveguide on the side of the waveguide core 300, 400, 500, or 600, the structure may not be restricted or defined hereto and the electrodes may even be formed in various structures and locations that permit voltage supply and current injection in the vicinity of the grating region based on various types of waveguides such as strip (channel) type, embedded strip type, and ridge type (e.g., “Fundamentals of Photonics”, B. E. A. Saleh and M. C. Teich, 2nd Edition, p. 310).

The reference marks used in the embodiments described above indicate as follows.

X: longitudinal direction of grating

Z: transverse direction of grating

Y: normal direction of grating

λ₀: wavelength of input light wave in a free space

Λ₉: period of grating

M: the number of photonic radiators in array

θ: longitudinal radiation angle of unit grating (angle from normal)

n_{eff}: effective refractive index of light waveguide where grating is formed

n_{c}: refractive index of clad covering light waveguide where grating is formed

### DESCRIPTION OF REFERENCE NUMERALS

100: light source
101-1, 101-2: 1:N power distributors
102: phase controller
103: phase-feeding line
104: photonic radiator
105: 1×M radiator array
106, 200, 300, 400, 500, 600: waveguide cores
201, 301, 401, 501, 601: gratings
202, 302, 402, 502, 602: input light waves
203: output light wave of diffraction pattern radiated from grating
304-1, 404-1, 604-1: p-type doped regions
304-2, 404-2, 604-2: n-type doped regions
504: p-type or n-type doped region
305-1, 305-2, 405-1, 405-2, 505-1, 505-2, 605-1, 605-2: electrodes
306, 406, 506, 606: rib parts or clad layers of light waveguides

### INDUSTRIAL APPLICABILITY

While embodiments of the present disclosure have been shown and described with reference to the accompanying drawings thereof, it will be understood by those persons having common knowledge related to the area of the present invention that various changes and modifications in form and details may be made therein without departing from the spirit and scope of the present disclosure as defined by the appended claims and their equivalents. For example, it may be allowable to achieve desired results although the embodiments of the present disclosure are performed in other sequences different from the descriptions, and/or the elements, such as system, structure, device, circuit, and so on, are combined or assembled in other ways different from the descriptions, replaced or substituted with other elements or their equivalents.

Therefore, other implementations, other embodiments, and equivalents of the appended claims may be included in the scope of the appended claims.

1. A photonic radiator forming a photonic phased array antenna, the photonic radiator comprising:
a light waveguide including a waveguide clad and a waveguide core using semiconductor materials; and
a grating periodically formed on an upper or lower part of the light waveguide,
wherein the photonic radiator is configured to receive an input light wave in a direction of the grating and the light waveguide, to radiate an output light wave to a space through scattering from the grating, and to vary an effective refractive index of the grating through voltage supply or current injection in the vicinity of the photonic radiator to adjust a radiation angle of the output light wave that is radiated to the space.

2. The photonic radiator of claim 1, wherein the photonic radiator is configured to adjust the radiation angle to widen a range in a longitudinal direction of the grating.

3. The photonic radiator of claim 1, wherein the photonic radiator is configured to vary the effective refractive index of the grating by using an electro-optic effect from the voltage supply or the current injection.

4. The photonic radiator of claim 3, wherein a p-n junction structure is formed in or in the vicinity of the grating to use the electro-optic effect from the voltage supply or the current injection.

5. The photonic radiator of claim 3, wherein the photonic radiator is formed of a p-i-n junction structure in or in the vicinity of the grating to use the electro-optic effect from the voltage supply or the current injection.

6. The photonic radiator of claim 1, wherein the photonic radiator is configured to vary the effective refractive index of the grating by using a thermo-optic effect from the current injection.

7. The photonic radiator of claim 6, wherein the photonic radiator is formed of a doped region with one of p-type or n-type in or in the vicinity of the grating to use the thermo-optic effect from the current injection, and configured to increase temperature of the grating through Joule heat that is generated by injecting a current into the doped region.

8. The photonic radiator of claim 6, wherein the photonic radiator is formed of a p-n junction in or in the vicinity of the grating to use the thermo-optic effect from the current injection, and configured to increase temperature of the grating through Joule heat that is generated by injecting a current into the p-n junction.

9. The photonic radiator of claim 8, wherein the photonic radiator is configured to supply a reverse-biased voltage to the p-n junction, which is formed in or in the vicinity of the grating, to use the thermo-optic effect, and configured to increase temperature of the grating through a breakdown current due to a voltage that is equal to or higher than a breakdown voltage.
